(19) United States
(12) Patent Application Publication
(10) Pub. No.: US 2009/0127249 A1
(43) Pub. Date: May 21, 2009

(54) Device for Triggering a Heating Element in a Motor Vehicle

(76) Inventors: Hans-Peter Bauer, Ditzingen (DE); Wolfgang Dippon, Weinstadt (DE)

Correspondence Address: KENYON & KENYON LLP, ONE BROADWAY, NEW YORK, NY, 10004, US

(21) Appl. No.: 11/883,684

(22) PCT Filed: Jan. 13, 2006
(86) PCT No.: PCT/EP2006/050208

§ 371 Date: Apr. 24, 2008

(30) Foreign Application Priority Data
Feb. 7, 2005 (DE) 10 2005 005 549.4

(51) Int. Cl. H05B 1/02

(52) U.S. Cl. 219/494

(57) ABSTRACT

A device for triggering a heating element in a motor vehicle. At least one connection is designed, at least in part, as an element which is installed under mechanical stress. The element is connected, at least at a first contact, in such a way that the latter detaches when a temperature is exceeded.

### BACKGROUND INFORMATION

Control units, which essentially include a switching element and a controller, are normally used for triggering heating elements in motor vehicles. Transistors are preferably used as switching means. Normally very high currents occur in such heating elements. In the event of a fault, such a device shuts off automatically, i.e., the current flow is interrupted by a suitable fuse. However, if a fault occurs in the triggering of the transistors or if the transistors themselves are defective, i.e., broken down in particular, switching off the current is very difficult and complicated. A damaged power transistor results in overheating of the control unit.

Such overheating may be reliably prevented by designing a connecting means, at least in part, as an element installed under mechanical stress and connecting the element, at least at a first contact, in such a way that it detaches when a limit temperature is exceeded. Such a thermal fuse operates completely independently of the electronics.

The electrical connection in particular is interrupted by the detachment.

### BRIEF DESCRIPTION OF THE DRAWINGS

FIG. 1 shows the important elements of the device according to the present invention.

FIGS. 2a and 2b show an element installed under mechanical stress.

### DETAILED DESCRIPTION

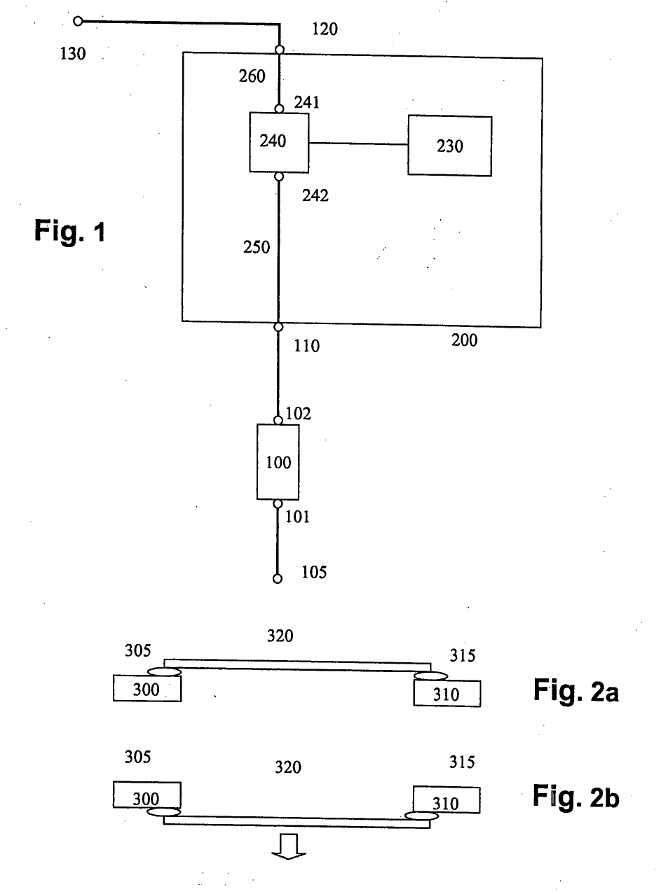

FIG. 1 basically shows elements of a control unit for triggering a heating element in a motor vehicle. A heating element is labeled 100. Its first terminal 101 is connected to a ground terminal 105 in the motor vehicle. A second terminal 102 of heating element 100 is connected to a first plug-in contact 110 of a control unit 200. A second plug-in contact 120 of control unit 200 is in turn connected to a supply voltage terminal 130 of the motor vehicle.

Control unit 200 includes, among other things, at least one controller 230, which triggers a switching means 240. A first terminal 241 of switching means 240 is connected to plug-in contact 120 via a first connecting means 260. A second terminal 242 of the switching means is connected to first plug-in contact 110 of control unit 200 via a second connecting means 250.

FIG. 1 shows the important elements, i.e., the switching means and controller 230 used for triggering heating element 100. The control unit may include further components in addition to those illustrated. Among other things, it may be provided that a means for detecting the current flow through the switching means or the heating element be provided between second terminal 242 and first plug-in contact 110.

Normally, controller 230 triggers switching means 240 in such a way that a desired current flows through heating element 100 or that the heating element attains a defined temperature.

Heating element 100 is preferably a glow plug of a diesel engine. Similar control units are, however, also used for other heating elements such as, for example, a heating element for heating a sensor, for example, a lambda sensor. Furthermore, such heating elements may also be used for heating other elements such as, for example, a rear window heater or an additional heater.

Switching means 240 is preferably designed as an appropriate transistor, in particular as a high-power field-effect transistor. Normally, first connecting means 260 and second connecting means 250 are designed using more or fewer solid conductors. For this purpose, suitable metal sheets or other track conductors are preferably used.

FIGS. 2a and 2b show two advantageous specific embodiments of a connecting means according to the present invention. The connecting means illustrated in FIG. 2a is first connecting means 260, which connects plug 120 to first terminal 241 of switching means 240. A first part of the connecting means is labeled 300. This first part of the connecting means 300 is preferably connected to first terminal 241.

The second part of the connecting means is labeled 310 and is preferably connected to plug-in contact 120 of the control unit. The second part of connecting means 310 is preferably also plug-in contact 120. The same applies to the first part of connecting means 300. This may also be the terminal pin of switching means 240. It is, however, also possible that appropriate metal parts are provided to form the first and second connecting means.

It is provided according to the present invention that the first part of connecting means 300 is connected to an element 320 via first contact 305 and the second part of connecting means 310 is connected to an element 320 via a second contact 315. According to the present invention, element 320 is installed in such a way that it is under mechanical stress. This means that element 320 is in the position illustrated only when contacted. As soon as one of the two contacts is detached, element 320 assumes a position such that the electrical connection between the first part of the connecting means and the second part of the connecting means is cut off.

This may be accomplished, for example, by designing element 320 as a spring which is contacted under stress. If one of the contacts is detached, the element separates from the other contact because of the stress and the current flow is interrupted.

It is preferably provided that first contact 305 is designed in such a way that it detaches when a limit temperature is exceeded. This is accomplished, for example, by implementing the first contact as a solder using solder tin, which has a relatively low melting point. In contrast, the second contact is implemented by a weld which detaches only at very high temperatures.

Alternatively to a weld, other permanent contacts may also be provided, for example, by screw joint or riveted joint. Instead of soldering, bonding with the aid of a conductive bond which detaches again at a higher temperature may also be provided.

It is important that the first contact is implemented in such a way that it detaches at a limit temperature. Due to the element installed under stress, this element 320 detaches from first part 300 of the connecting means due to the mechanical stress and interrupts the electrical connection between the switching means and plug 120.

It is advantageous in particular if the component that gives off the most heat loss is mounted on the elastic element. This is preferably the switching means. In this way, overheating of the switching means results in a temperature increase of the elastic element and thus in the contact. In other words, at an excessive temperature of the switching means, the first contact detaches and the current flow is automatically interrupted.

According to the present invention, element 320 may assume two positions. In a first position, element 320 is not under mechanical stress. No current flow is possible in this first position. In a second position, the element is under mechanical stress. Current flows in this second position. The element is installed in the second position and held with the aid of the two contacts. In the event of non-admissible heating, at least one of the contacts detaches. Due to the mechanical stress, element 320 moves into the second position without being further acted upon and the current flow is interrupted.

The element under stress may be implemented in different ways. It may thus be provided, for example, that an elastic element is used which is contacted under stress. If one of the contacts is detached, the elastic element returns to its original position and interrupts the connection.

It may furthermore be provided that an external force acts upon the element and interrupts the connection by detaching the contact. The force of gravity in particular is to be considered such an external force, i.e., the element is situated underneath the connecting means of the second part of the connecting means. If the contact is detached due to the elevated temperature, the element moves downward due to the force of gravity and detaches the connection.

Such an embodiment is depicted in FIG. 2b. FIG. 2b differs from the embodiment of FIG. 2a only in the way that the element is situated with respect to an acting force. The direction of the force's action is indicated by an arrow. On the one hand, the force may be caused by the force of gravity. However, the action of an electromagnetic force, for example, may also be provided.

In this case it is advantageous in particular if both contacts are designed in such a way that they detach when a limit temperature is exceeded. As a result, if the limit temperature is exceeded, both contacts detach and the element drops due to the force of gravity, interrupting the connection.

The procedure according to the present invention in this connection is not limited to the fact that the first connecting means is designed accordingly. It may also be provided that, alternatively or additionally, the second connecting means 250, which connects first plug 110 and second terminal 242 of switching means 240, is similarly designed. It may be furthermore provided that only the connecting means are partially designed as illustrated in FIG. 2. This is practical in particular if further components are provided between the plugs of the control unit and the terminals of the switching means. It may be furthermore provided that the connection between control unit 200 and heating element 100 and/or between heating element 100 and ground terminal 105 and/or between supply voltage terminal 130 and plug-in contact 120 are designed in a similar way.

It may be furthermore also provided that multiple heating elements are connected to a control unit.

The advantage of this procedure is that this thermal fuse is fully independent of the electronics or of an outside influence. When a limit temperature is exceeded, the electrical connection is detached only by the mechanical pre-stress and/or by an externally acting force such as the force of gravity. By using suitable contacts such as, for example, suitable soldering means or conductive bonds, any desired temperature range in which the connection is detached may be set.

1-7. (canceled)

8. A device for triggering a heating element in a motor vehicle, comprising:
at least one first contact; and
at least one electrical connection designed, at least in part, as a spring element which is installed under mechanical stress, the spring element being connected to the at least one first contact in such a way that the at least one first contact detaches when a limit temperature is exceeded and in this way the spring element goes into a position without stress and interrupts a flow of current through the spring element.

9. The device according to claim 8, wherein the electrical connection connects a switching element to one of a supply voltage, a heating element, and a ground terminal.

10. The device according to claim 8, wherein the at least one first contact is formed by a soldering point.

11. The device according to claim 8, wherein the at least one first contact is formed by a conductive bond.

12. The device according to claim 8, further comprising a second contact implemented by a permanent connection.

13. The device according to claim 12, wherein the second contact is implemented by one of a weld, a riveted joint, and a screw joint.

14. The device according to claim 8, wherein the heating element includes at least one glow plug of a diesel engine.
